(19) United States
(12) Patent Application Publication
(10) Pub. No.: US 2026/0142572 A1
(43) Pub. Date: May 21, 2026

(54) POWER SUPPLY DEVICE

(71) Applicant: ROHM CO., LTD., Kyoto (JP)

(72) Inventor: Takatsugu WACHI, Kyoto (JP)

(21) Appl. No.: 19/447,758

(22) Filed: Jan. 13, 2026

Related U.S. Application Data
(63) Continuation of application No. PCT/JP2024/019749, filed on May 29, 2024.

(30) Foreign Application Priority Data
Jul. 20, 2023 (JP) 2023-118037

(51) Int. Cl. H02M 3/158

(52) U.S. Cl. CPC H02M 3/158

(57) ABSTRACT

First to fourth switching elements are connected in series from a reference node to a power supply node that receives an input voltage. A power supply device controls states of the switching elements so as to divide the input voltage, and steps down an intermediate voltage obtained by the division so as to generate an output voltage. The states of the first to the fourth switching elements are switched among first to third states, on the basis of information of the output voltage and current information of an inductor. In the first state, the second and the fourth switching elements are ON while the first and the third switching elements are OFF. In the second state, the second and the fourth switching elements are OFF while the first and the third switching elements are ON. In the third state, the first to the fourth switching elements are all OFF.

### CROSS-REFERENCE TO RELATED APPLICATIONS

This nonprovisional application is a continuation application of International Patent Application No. PCT/JP2024/019749 filed on May 29, 2024, which claims priority to Japanese Patent Application No. 2023-118037 filed on July 20, 2023, the entire contents of which are hereby incorporated by reference.

### TECHNICAL FIELD

The present disclosure relates to a power supply device.

### BACKGROUND ART

A power supply device, which steps down an input voltage using a plurality of switching so as to generate a desired output voltage, is widely used.

### List of Citations

### Patent Literature

Patent Document 1: JP-A-2020-89043

### BRIEF DESCRIPTION OF DRAWINGS

FIG. 1 is an overall configuration diagram of a power supply device according to an embodiment of the present disclosure.

FIG. 2 is a diagram illustrating three states that four switching elements can have, according to the embodiment of the present disclosure.

FIG. 3 is a diagram for explaining current flows when switching control is performed in the power supply device according to the embodiment of the present disclosure.

FIG. 4 is a configuration diagram of the power supply device illustrating an internal configuration example of a control circuit, according to the embodiment of the present disclosure.

FIG. 5 is a timing chart of the power supply device in a heavy load state, according to the embodiment of the present disclosure.

FIG. 6 is a relationship diagram between a feedback voltage and an output signal of a light load detection circuit, according to a first example of the embodiment of the present disclosure.

FIG. 7 is a flowchart of a power supply device, according to the first example of the embodiment of the present disclosure.

FIG. 8 is a timing chart of the power supply device in a light load state, according to the first example of the embodiment of the present disclosure.

FIG. 9 is a timing chart of the power supply device in the light load state, according to the first example of the embodiment of the present disclosure.

FIG. 10 is a flowchart of the power supply device, according to a second example of the embodiment of the present disclosure.

### DESCRIPTION OF EMBODIMENTS

Hereinafter, examples of an embodiment of the present disclosure is specifically described with reference to the drawings. In the drawings to be referred to, the same part is denoted by the same numeral or symbol, and overlapping description of the same part is omitted as a rule. Note that in this specification, for simple description, by referring to a symbol or sign indicating information, a signal, a physical quantity, a functional unit, a circuit, an element, a component, or the like, a name of the information, the signal, the physical quantity, the functional unit, the circuit, the element, the component, or the like corresponding to the symbol or sign may be omitted or shortened.

First, some definitions of terms used for describing the embodiment of the present disclosure are given below. A ground means a reference conductive part having a reference potential of 0 V (zero volts) or means the reference potential of 0 V itself. If a certain component, electrode, or node is connected to the ground, it means that the component, electrode, or node is connected to a reference node having the reference potential of 0 V. The reference node and the ground can be read as each other.

A level means a potential level (electric potential level), and a high level has a higher potential than a low level for any given signal or voltage. For any given signal or voltage, if the signal or voltage is at high level, it strictly means that a level of the signal or voltage is at high level, and if the signal or voltage is at low level, it strictly means that a level of the signal or voltage is at low level. For any given signal or voltage, switching from low level to high level is referred to as a rising edge, while switching from high level to low level is referred to as a falling edge.

Any switching element can be constituted of a transistor. For any transistor constituting an FET (field-effect transistor) including MOSFET, ON state means a state where the transistor is conductive between the drain and the source, while OFF state means a state where the transistor is non-conductive between the drain and the source (a cut-off state). The same is true for a transistor that is not classified as an FET. A MOSFET is understood to be an enhancement type MOSFET unless otherwise noted. MOSFET is an abbreviation of "metal-oxide-semiconductor field-effect transistor". In addition, in any MOSFET, it can be understood that the backgate is short-circuited to the source unless otherwise noted.

Hereinafter, for any switching element (transistor), ON state and OFF state may be simply expressed as ON and OFF. For any switching element, switching from OFF state to ON state is expressed as turning on, and switching from ON state to OFF state is expressed as turning off. In addition, for any switching element, a period during which a switching element is in ON state is referred to as ON period, while a period during which a switching element is in OFF state is referred to as OFF period.

For any signal having a signal level of high level or low level, a period during which the signal level is high level is referred to as a high level period, while a period during which the signal level is low level is referred to as a low level period. The same is true for any voltage having a voltage level of high level or low level.

Connection between any parts forming a circuit, such as circuit elements, wirings, and nodes can be understood to mean electric connection unless otherwise noted.

Supposing that any two voltages to be compared are voltages v1 and v2, "v1 > v2" means that the voltage v1 is higher than the voltage v2, while "v1 < v2" means that the voltage v1 is lower than the voltage v2. The same is true for other expression including a physical quantity other than a voltage.

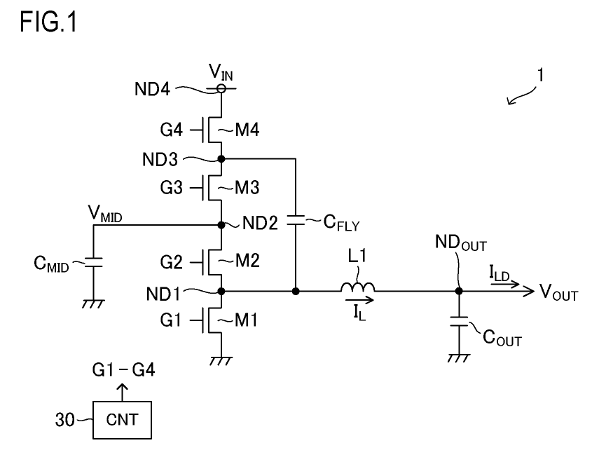

FIG. 1 illustrates an overall configuration of a power supply device 1 according to the embodiment of the present disclosure. The power supply device 1 receives supply of a positive input voltage V_{IN} from a not shown voltage source, and steps down the input voltage V_{IN} so as to generate a positive output voltage V_{OUT}. The output voltage V_{OUT} is lower than the input voltage V_{IN}. The power supply device 1 stabilizes the output voltage V_{OUT} at a predetermined target voltage. In other words, in a steady state, the output voltage V_{OUT} is substantially equal to the target voltage. Hereinafter, the target voltage is denoted by a symbol "V_{TG}". In the power supply device 1, an intermediate voltage V_{MID} is generated. The output voltage V_{OUT} is lower than the intermediate voltage V_{MID}. In addition, in the steady state, the intermediate voltage V_{MID} is substantially 1/2 of the input voltage V_{IN}. Therefore, "V_{IN} > 2 × V_{OUT}" holds. As long as "V_{IN} > 2 × V_{OUT}" holds, values of the input voltage V_{IN} and the output voltage V_{OUT} are arbitrary. In other words, as long as "V_{IN} > 2 × V_{TG}" holds, values of the input voltage V_{IN} and the target voltage V_{TG} are arbitrary. For instance, the input voltage V_{IN} is 48 V, and the target voltage V_{TG} (i.e., the output voltage V_{OUT} in the steady state) is 12 V or 5 V.

Note that for the power supply device 1, the steady state means a state where the output voltage V_{OUT} is stabilized at the target voltage V_{TG}, after the power supply device 1 is activated and the output voltage V_{OUT} is increased from 0 V to reach the target voltage V_{TG.}

The power supply device 1 includes switching elements M1 to M4, capacitors C_{FLY}, C_{MID} and C_{OUT}, an inductor L1, and a control circuit 30. The capacitor C_{FLY} can be referred to as flying capacitor. The capacitor C_{MID} can be referred to as an intermediate capacitor. The capacitor C_{OUT} can be referred to as an output capacitor.

The power supply device 1 includes a buck converter and a stacked converter. The buck converter in the power supply device 1 includes the switching elements M1 and M2, and the inductor L1, so as to generate the output voltage V_{OUT} at an output node ND_{OUT} by stepping down the intermediate voltage V_{MID}. It may be understood that the capacitor C_{OUT} is also included in components of the buck converter. The switching elements M1 and M2 function as a low-side switching element and a high-side switching element of the buck converter. The stacked converter in the power supply device 1 includes the switching elements M3 and M4, and the capacitor C_{FLY}, so as to generate the intermediate voltage V_{MID} from the input voltage V_{IN}. The capacitor C_{MID} can also be understood to be included in components of the stacked converter.

In this embodiment, each of the switching elements M1 to M4 is constituted of an N-channel type MOSFET. For this reason, in the following description, the switching elements M1 to M4 may be referred to as transistors M1 to M4.

The transistors M1 to M4 are connected in series between the ground and a node ND4. The transistor M1 is disposed between the ground and a node ND1, the transistor M2 is disposed between the nodes ND1 and ND2, the transistor M3 is disposed between the nodes ND2 and ND3, and the transistor M4 is disposed between the nodes ND3 and ND4. More specifically, the source of the transistor M1 is connected to the ground. The drain of the transistor M1 and the source of the transistor M2 are connected to the node ND1. The drain of the transistor M2 and the source of the transistor M3 are connected to the node ND2. The drain of the transistor M3 and the source of the transistor M4 are connected to the node ND3. The drain of the transistor M4 is connected to the node ND4. The node ND4 is a power supply node that receives the input voltage V_{IN}. In other words, the input voltage V_{IN} is supplied to the node ND4. Signals supplied to the gates of the transistors M1 to M4 are referred to as gate signals G1 to G4, respectively.

The capacitor C_{FLY} is disposed between the nodes ND3 and ND1. In other words, a first terminal of the capacitor C_{FLY} is connected to the node ND3, and a second terminal of the capacitor C_{FLY} is connected to the node ND1.

The capacitor C_{MID} is disposed between the node ND2 and the ground. In other words, a first terminal of the capacitor C_{MID} is connected to the node ND2, and a second terminal of the capacitor C_{MID} is connected to the ground. The first terminal of the capacitor C_{MID} corresponds to a positive terminal of the capacitor C_{MID}. A voltage at the node ND2 is the intermediate voltage V_{MID}. In other words, the intermediate voltage V_{MID} is generated across both terminals of the capacitor C_{MID}.

The inductor L1 is disposed between the node ND1 and the output node ND_{OUT}. In other words, a first terminal of the inductor L1 is connected to the node ND1, and a second terminal of the inductor L1 is connected to the output node ND_{OUT}.

The capacitor C_{OUT} is disposed between the output node ND_{OUT} and the ground. In other words, a first terminal of the capacitor C_{OUT} is connected to the output node ND_{OUT}, and a second terminal of the capacitor C_{OUT} is connected to the ground. The first terminal of the capacitor C_{OUT} corresponds to a positive terminal of the capacitor C_{OUT}. A voltage at the output node ND_{OUT} is the output voltage V_{OUT}. In other words, the output voltage V_{OUT} is generated across both terminals of the capacitor C_{OUT}.

The control circuit 30 is connected to the gates of the transistors M1 to M4, and supplies the gate signals G1 to G4 to the transistors M1 to M4, so as to individually control the states of the transistors M1 to M4 (ON/OFF state). When the control circuit 30 controls the states of the transistors M1 to M4, the desired output voltage V_{OUT} lower than the input voltage V_{IN} is generated at the output node ND_{OUT}. It may be possible to form the control circuit 30 using a semiconductor integrated circuit.

Any one of the gate signals G1 to G4 is referred to as a gate signal Gx. One of the transistors M1 to M4, whose gate receives the gate signal Gx, is referred to as a transistor Mx. When the gate signal Gx has high level, the transistor Mx is ON state, and when the gate signal Gx has low level, the transistor Mx is OFF state. Therefore, the transistor M1 is ON state during the high level period of the gate signal G1, and the transistor M1 is OFF state during the low level period of the gate signal G1. Similarly, the transistor M2 is ON state during the high level period of the gate signal G2, and the transistor M2 is OFF state during the low level period of the gate signal G2. The same is true for the transistors M3 and M4. The gate signal Gx of high level has a potential that is higher than a potential higher than the source potential of the transistor Mx by the gate threshold voltage of the transistor Mx. The gate signal Gx of low level may have a potential that is substantially equal to the source potential of the transistor Mx.

The output node ND_{OUT} is connected to a not shown load. The load is any load that is driven on the basis of the output voltage V_{OUT}. A current supplied from the output node ND_{OUT} to the load is referred to as a load current I_{LD}. The load current I_{LD} corresponds to an output current of the power supply device 1. In addition, a current that flows through the inductor L1 is referred to as an inductor current I_{L}. It is supposed that the inductor current I_{L} from the node ND1 to the output node ND_{OUT} has a positive polarity, and that the inductor current I_{L} from the output node ND_{OUT} to the node ND1 has a negative polarity.

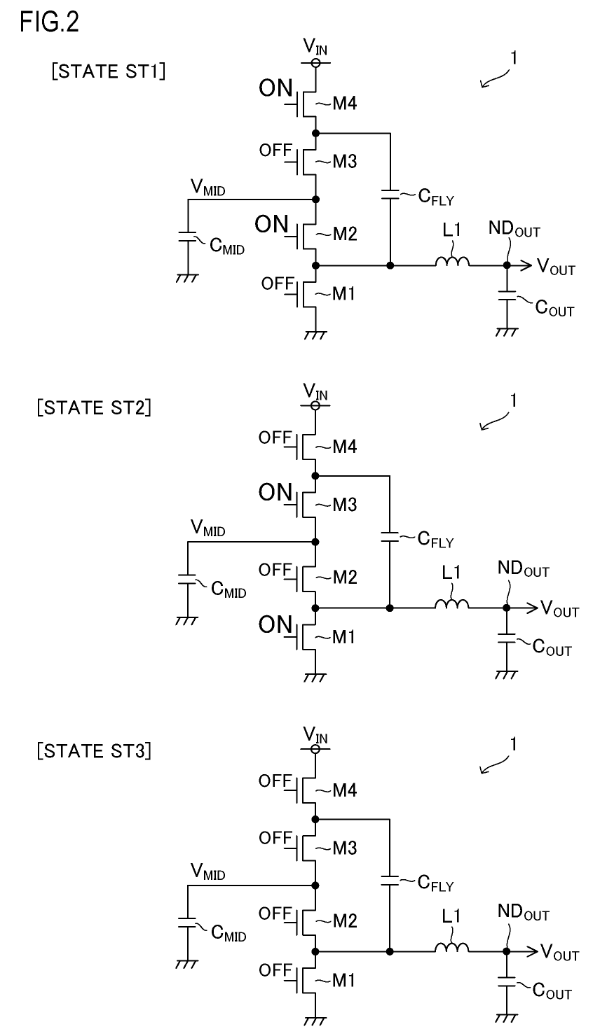

The control circuit 30 can set the states of the transistors M1 to M4 to any one of states ST1, ST2 and ST3 illustrated in FIG. 2. In other words, the control circuit 30 can switch the states of the transistors M1 to M4 among the states ST1, ST2 and ST3. In the state ST1, the transistors M2 and M4 are ON states while the transistors M1 and M3 are OFF state. In the state ST2, the transistors M2 and M4 are OFF state while the transistors M1 and M3 are ON state. In the state ST3, the transistors M1 to M4 are all OFF state.

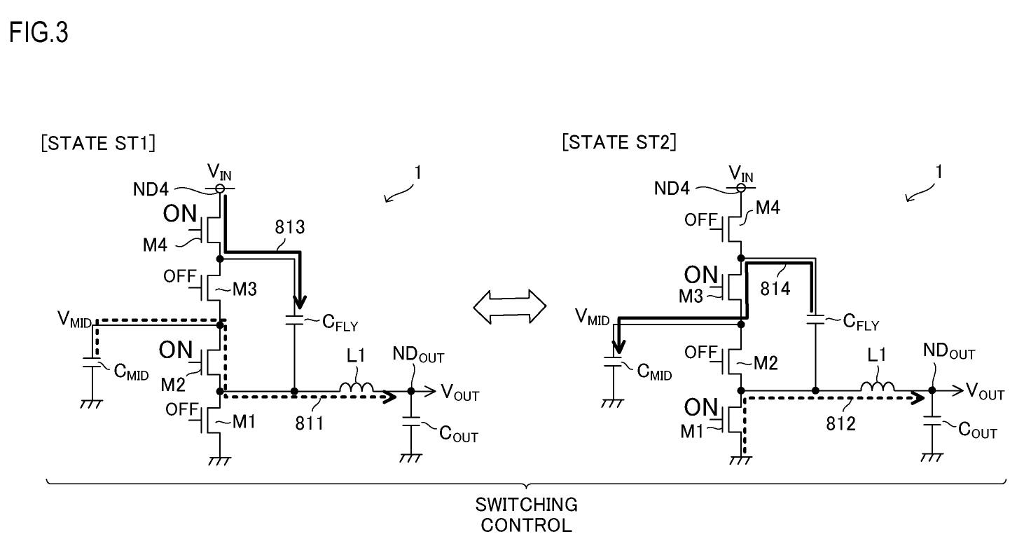

The control circuit 30 can perform a switching control for alternately switching the states of the transistors M1 to M4 between the states ST1 and ST2. With reference to FIG. 3, currents generated when the switching control is performed are described below. Note that with respect to a potential at the second terminal of the capacitor C_{FLY} (i.e., a potential at the node ND1), a current in the direction of increasing a potential at the first terminal of the capacitor C_{FLY} (i.e., a potential at the node ND3) is a charging current for the capacitor C_{FLY}, and a current in the opposite direction thereof is a discharge current for the capacitor C_{FLY}. For the capacitor C_{MID}, a current in the direction of increasing the intermediate voltage V_{MID} is a charging current, and a current in the direction of decreasing the intermediate voltage V_{MID} is a discharge current.

In the state ST1, currents 811 and 813 are generated. The current 811 is a current from the capacitor C_{MID} to the output node ND_{OUT} through the transistor M2 and the inductor L1, and is generated by discharging of the capacitor C_{MID}. The current 813 is a current from the node ND4 as an application terminal of the input voltage V_{IN} to the capacitor C_{FLY} through the transistor M4, and the capacitor C_{FLY} is charged by the current 813.

In the state ST2, currents 812 and 814 are generated. The current 812 flows from the ground to the output node ND_{OUT} through the transistor M1 and the inductor L1. The current 814 is a current from the capacitor C_{FLY} to the positive terminal of the capacitor C_{MID} through the transistor M3. The current 814 is generated when the capacitor C_{FLY}is discharged, and contributes to charging of the capacitor C_{MID}.

In the state ST1, the transistors M2 and M4 are ON, and hence the state ST1 for the capacitors C_{FLY} and C_{MID} is equivalent to the state where the capacitors C_{FLY} and C_{MID} are connected in series. In addition, in the state ST2, the capacitors C_{FLY} and C_{MID} are connected in parallel through the switching elements M1 and M3. As a result, the transistors M1 to M4 and the capacitors C_{FLY} and C_{MID} form a switched capacitor circuit. For this reason, in the steady state, the intermediate voltage V_{MID} as a voltage at the positive terminal of the capacitor C_{MID} is substantially a voltage (V_{IN}/2). In other words, the intermediate voltage V_{MID} corresponding to a divided voltage of the input voltage V_{IN} is generated by the switching control. In this way, the control circuit 30 allows the circuit including the transistors M1 to M4 and the capacitors C_{MID} and C_{FLY} to work as the switched capacitor circuit in the switching control, and thus the intermediate voltage V_{MID} is generated at the node ND2.

On the other hand, a synchronous buck converter that steps down the intermediate voltage V_{MID} is constituted of the transistors M1 and M2 and the inductor L1. For this reason, the power supply device 1 can be referred to as a hybrid buck converter in which the switched capacitor circuit and the synchronous buck converter are fused.

By adopting the method of reducing the input voltage V_{IN} by half using the switched capacitor circuit, and further stepping down the obtained intermediate voltage V_{MID} using the synchronous buck converter, it is possible to obtain high efficiency.

For instance, a case is supposed in which the output voltage V_{OUT} of 12 V is generated from the input voltage V_{IN} of 48 V. As a reference method, there is a method of stepping down 48 V to 12 V directly using a simple synchronous buck converter. In the reference method, a square wave voltage (a square wave voltage changing between approximately 0 V and 48 V) is generated by switching the input voltage V_{IN} of 48 V, and the square wave voltage is rectified and smoothed so that the output voltage of 12 V is obtained. In contrast, in the power supply device 1, a square wave voltage (a square wave voltage changing between approximately 0 V and 24 V) is generated by switching the voltage (V_{IN}/2), and the square wave voltage is rectified and smoothed so that the output voltage of 12 V is obtained. For this reason, compared with the power supply device according to the reference method, the power supply device 1 can suppress a switching loss to be low.

The switching loss is reduced by a plurality of factors, some of which are exemplified below. In the reference method, a switching duty ratio is relatively small. If the switching duty ratio is relatively small, an influence of a loss in a period during which an instantaneous value increases and a loss in a period during which the same is decreased are relatively large, in the square wave voltage. In contrast, if the power supply device 1 is used, the input voltage to the synchronous buck converter is the voltage (V_{IN}/2), and hence the switching duty ratio is relatively large compared with the reference method, which improves the switching loss. In addition, in the switching process, charge and discharge of various parasitic capacitances are generated, and in the power supply device 1, because the input voltage to the synchronous buck converter is the voltage (V_{IN}/2), a loss accompanying the charge and discharge of the parasitic capacitance can be suppressed to be relatively low compared with the reference method.

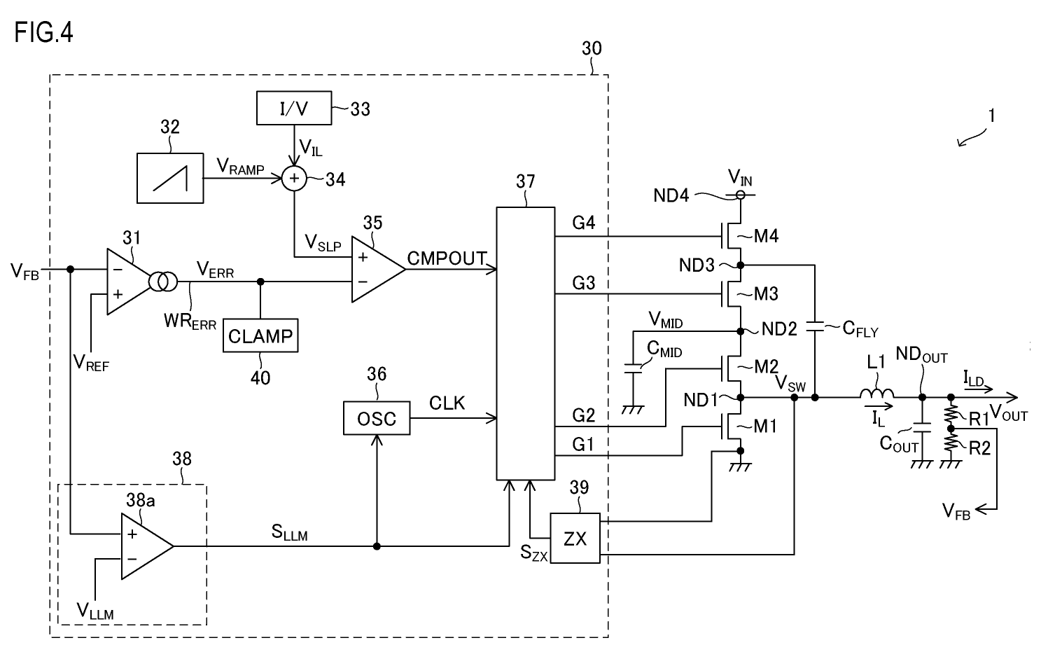

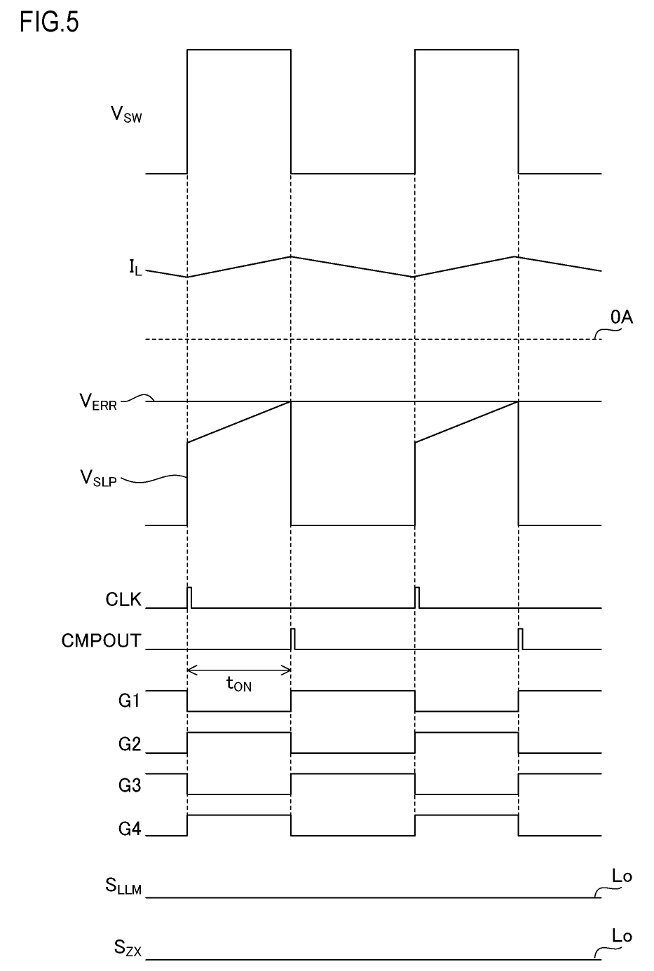

FIG. 4 illustrates a configuration diagram of the power supply device 1, in which an internal configuration example of the control circuit 30 is shown. FIG. 5 illustrates a timing chart of the power supply device 1 in a heavy load state. If the load current I_{LD} is properly large, a signal S_{LLM} described later is kept at low level. The state where the signal S_{LLM} is kept at low level is referred to as the heavy load state here, for convenience sake. In the heavy load state, the power supply device 1 is operated in a current continuous mode in which "I_{L} > 0" holds always. When the signal S_{LLM} is kept at low level, the switching control is continuously performed. FIG. 5 shows waveforms of a switch voltage V_{SW}, the inductor current I_{L}, an error voltage V_{ERR}, a slope voltage V_{SLP}, and signals CLK, CMPOUT, G1, G2, G3, G4, S_{LLM}, and S_{ZX}, from top to bottom. When the signal S_{LLM} is kept at low level, the signal S_{ZX} is also kept at low level. The switch voltage V_{SW} is a voltage at the node ND1.

The control circuit 30 includes an error amplifier 31, a ramp circuit 32, a current information acquisition circuit 33, an adder 34, a PWM comparator 35, an oscillation circuit 36, a controller 37, a light load detection circuit 38, a backward current detection circuit 39, and a clamp circuit 40. In addition, the power supply device 1 is provided with resistors R1 and R2. A first terminal of the resistor R1 is connected to the output node ND_{OUT}, a second terminal of the resistor R1 is connected to a first terminal of the resistor R2, and a second terminal of the resistor R2 is connected to the ground. A feedback voltage V_{FB} corresponding to the output voltage V_{OUT} is generated at a connection node of the resistors R1 and R2. The feedback voltage V_{FB} is a divided voltage of the output voltage V_{OUT}, and therefore is proportional to the output voltage V_{OUT}. The resistors R1 and R2 constitute a feedback voltage generation circuit that generates the feedback voltage V_{FB}. The feedback voltage V_{FB} is supplied to the control circuit 30. However, the feedback voltage generation circuit may be understood to be included in components of the control circuit 30. In addition, it may be possible that the output voltage V_{OUT} itself is the feedback voltage V_{FB}. In any case, the feedback voltage V_{FB} contains information of the output voltage V_{OUT} (in detail, information indicating a value of the output voltage V_{OUT}).

The error amplifier 31 is a transconductance amplifier of a current output type. The error amplifier 31 includes an inverting input terminal, a non-inverting input terminal, and an output terminal. The feedback voltage V_{FB} is supplied to the inverting input terminal of the error amplifier 31. The non-inverting input terminal of the error amplifier 31 is supplied with a predetermined reference voltage V_{REF}. The reference voltage V_{REF} is a DC voltage having a predetermined positive voltage value, and is generated by a not shown reference voltage generation circuit in the control circuit 30. The output terminal of the error amplifier 31 is connected to a wiring WR_{ERR}. Note that when the power supply device 1 is activated, a soft start control may be performed in which a value of the reference voltage V_{REF} is gradually increased from 0 V to the predetermined positive voltage value, but in the following description, it is ignored that there is the soft start control.

The error amplifier 31 outputs from its own output terminal a current signal corresponding to a difference between the feedback voltage V_{FB} and the reference voltage V_{REF}, so as to allow the wiring WR_{ERR} to generate the error voltage V_{ERR} corresponding to the difference between the feedback voltage V_{FB} and the reference voltage V_{REF}. Specifically, the error amplifier 31 outputs a current from its own output terminal to the wiring WR_{ERR} so that the error voltage V_{ERR} is increased, if the feedback voltage V_{FB} is lower than the reference voltage V_{REF}, while it pulls in a current from the wiring WR_{ERR} to its own output terminal so that the error voltage V_{ERR} is decreased, if the feedback voltage V_{FB} is higher than the reference voltage V_{REF}. Note that although not particularly illustrated, a phase compensation circuit including a capacitor may be connected between the wiring WR_{ERR} and the ground.

The ramp circuit 32 generates a ramp voltage V_{RAMP}, which simply increases from a predetermined initial voltage V_{INT} with a predetermined change rate during ON period of the transistor M2. In the ramp circuit 32, the initial voltage V_{INT} is 0 V for example, but it can be different from 0 V. During OFF period of the transistor M2, the ramp voltage V_{RAMP} is fixed to the initial voltage V_{INT}.

The current information acquisition circuit 33 acquires current information of the inductor L1, and generates a sense voltage V_{IL} indicating the current information of the inductor L1. The current information of the inductor L1 is information indicating a value of the inductor current I_{L}. The sense voltage V_{IL} has a voltage value proportional to the value of the inductor current I_{L} with a positive proportionality coefficient. Therefore, the sense voltage V_{IL} increases along with an increase in the inductor current I_{L}, while the sense voltage V_{IL} decreases along with a decrease in the inductor current I_{L}. For instance, "V_{IL} = k_{IV} × I_{L}" may hold, where k_{IV} is a predetermined positive coefficient.

As long as the sense voltage V_{IL} indicates the current information of the inductor L1, the method of generating the sense voltage V_{IL} is arbitrary. For instance, the sense voltage V_{IL} may be generated by directly detecting the inductor current I_{L} using a current sensor. Here, the current sensor may be a shunt resistor (not shown) inserted between the inductor L1 and the node ND1 in series. Alternatively, for example, the sense voltage V_{IL} may be generated by detecting the current flowing in the transistor M2 (i.e., the inductor current I_{L}) during ON period of the transistor M2, or by detecting the current flowing in the transistor M1 (i.e., the inductor current I_{L}) during ON period of the transistor M1. Other than that, the sense voltage V_{IL} may be generated by detecting the voltage at any point where the voltage corresponding to the inductor current I_{L} is generated.

The adder 34 adds the sense voltage V_{IL} to the ramp voltage V_{RAMP} so as to generate the sum voltage of them as the slope voltage V_{SLP}. In other words, "V_{SLP} = V_{RAMP} + V_{IL}" holds.

The PWM comparator 35 compares the error voltage V_{ERR} with the slope voltage V_{SLP}, so as to generate and output the signal CMPOUT indicating the comparison result. The error voltage V_{ERR} is input to an inverting input terminal of the PWM comparator 35, and the slope voltage V_{SLP} is input to a non-inverting input terminal of the PWM comparator 35. The PWM comparator 35 outputs the signal CMPOUT of low level when "V_{SLP} < V_{ERR}" holds, and outputs the signal CMPOUT of high level when "V_{SLP} > V_{ERR}" holds. When "V_{SLP} = V_{ERR}" holds, the signal CMPOUT has low level or high level.

An oscillation circuit 36 generates and outputs the clock signal CLK by an oscillation operation. The clock signal CLK is a square wave signal having a predetermined frequency f_{PWM}, and has a signal level of alternate high level and low level. The clock signal CLK has an arbitrary duty ratio. Here, it is supposed that the clock signal CLK has low level in principle, and has high level for a very short period of time at an interval that is the reciprocal of the frequency f_{PWM} (see FIG. 5). The signal S_{LLM} is input to the oscillation circuit 36, and an influence exerted by the signal S_{LLM} on the operation of the oscillation circuit 36 will be described later.

The signal CMPOUT and the clock signal CLK are input to the controller 37. The controller 37 is connected to the gates of the transistors M1 to M4, and supplies the gate signals G1 to G4 to the transistors M1 to M4. In the switching control, by a trigger of a predetermined level change in the clock signal CLK, the controller 37 allows the gate signals G2 and G4 to generate rising edges (i.e., changes the levels of the gate signals G2 and G4 from low level to high level), so as to turn on the transistors M2 and M4, and allows the gate signals G1 and G3 to generate falling edges (i.e., changes the levels of the gate signals G1 and G3 from high level to low level), so as to turn off the transistors M1 and M3. Here, the predetermined level change in the clock signal CLK is a change from low level to high level of the clock signal CLK, but it may be a change from high level to low level of the clock signal CLK.

After turning on of the transistors M2 and M4 and turning off of the transistors M1 and M3, the slope voltage V_{SLP} is simply increased, and the state where "V_{SLP} < V_{ERR}" holds is changed to the state where "V_{SLP} > V_{ERR}" holds, so that a rising edge is generated on the signal CMPOUT. If a rising edge is generated on the signal CMPOUT in the switching control, the controller 37 allows the gate signals G2 and G4 to generate falling edges, so as to turn off the transistors M2 and M4, and allows the gate signals G1 and G3 to generate rising edges so as to turn on the transistors M1 and M3. Along with turning off of the transistor M2, the ramp voltage V_{RAMP} is decreased to the initial voltage V_{INT} that is sufficiently low, and hence the state where "V_{SLP} < V_{ERR}" holds is restored, and a falling edge is promptly generated on the signal CMPOUT. Note that in the switching control, the period of time after the transistors M2 and M4 are turned on while the transistors M1 and M3 are turned off, until the transistors M2 and M4 are turned off while the transistors M1 and M3 are turned on, is referred to as a time t_{ON}.

If "V_{OUT} = V_{TG}" holds, "V_{FB} = V_{REF}" holds. If "V_{OUT} < V_{TG}" holds through an increase in the load current I_{LD} from the start point of the state where "V_{OUT} = V_{TG}" holds, "V_{FB} < V_{REF}" holds, and hence the error voltage V_{ERR} is increased. The increase in the error voltage V_{ERR} causes an increase in the ON period of the transistor M2. When ON period of the transistor M2 is increased, the inductor current I_{L} is increased, and as a result, the output voltage V_{OUT} is increased toward the target voltage V_{TG}. On the contrary, if "V_{OUT} > V_{TG}" holds through a decrease in the load current I_{LD} from the start point of the state where "V_{OUT} = V_{TG}" holds, "V_{FB} > V_{REF}" hold, and hence the error voltage V_{ERR} is decreased. The decrease in the error voltage V_{ERR} causes a decrease in the ON period of the transistor M2. When ON period of the transistor M2 is decreased, the inductor current I_{L} is decreased, and as a result, the output voltage V_{OUT} is decreased toward the target voltage V_{TG}. In this way, in the switching control, it is controlled so that a difference between the output voltage V_{OUT} and the target voltage V_{TG} is decreased.

The time t_{ON} described above depends on the error voltage V_{ERR} (i.e., depends on the information of the output voltage V_{OUT}), and depends on the sense voltage V_{IL} (i.e., depends on the current information of the inductor L1). In other words, the controller 37 performs the switching control of the transistors M1 to M4 in synchronization with the clock signal CLK, on the basis of the information of the output voltage V_{OUT} and the current information of the inductor L1. In the switching control, the controller 37 turns on the transistors M2 and M4 while turns off the transistors M1 and M3, by a trigger of the predetermined level change in the clock signal CLK, and after that, when the time t_{ON} elapses, which corresponds to the information of the output voltage V_{OUT} and the current information of the inductor L1, the transistors M2 and M4 are turned off while the transistors M1 and M3 are turned on.

By the switching control described above, the controller 37 generates the intermediate voltage V_{MID} across both terminals of the capacitor C_{MID}, and controls the buck converter including the transistors M1 and M2 and the inductor L1 to step down the intermediate voltage V_{MID}, so as to generate the output voltage V_{OUT} at the output node ND_{OUT}.

The feedback voltage V_{FB} is input to the light load detection circuit 38. The light load detection circuit 38 determines a degree of amplitude of the load current I_{LD} on the basis of the feedback voltage V_{FB}, so as to generate and output the signal S_{LLM} that is a light load detection signal corresponding to the determination result. The signal S_{LLM} is a binary signal having low level or high level. If the load current I_{LD} is relatively large, the signal S_{LLM} is kept at low level, but if the load current I_{LD} is relatively small, the signal S_{LLM} may have high level. The light load detection circuit 38 includes at least a comparator 38a. The feedback voltage V_{FB} and a predetermined light load threshold voltage V_{LLM} are input to the comparator 38a. Here, it is supposed that the feedback voltage V_{FB} is input to a non-inverting input terminal of the comparator 38a, and that the light load threshold voltage V_{LLM} is input to and inverting input terminal of the comparator 38a. The light load threshold voltage V_{LLM} has a predetermined positive DC voltage value, and is higher than the reference voltage V_{REF}. In the comparator 38a, the feedback voltage V_{FB} is compared with the light load threshold voltage V_{LLM}, and the comparison result is reflected on the signal S_{LLM}. In a state where the feedback voltage V_{FB} is sufficiently low, the signal S_{LLM} has low level. When the feedback voltage V_{FB} is increased so that "V_{FB} > V_{LLM}" holds, the signal S_{LLM} has high level. A detailed operational example of the light load detection circuit 38 will be described later. The signal S_{LLM} is input to the oscillation circuit 36 and the controller 37.

The backward current detection circuit 39 is connected to the node ND1 and the ground. For instance, the backward current detection circuit 39 compares the switch voltage V_{SW} with ground potential during ON period of the transistor M1, so as to detect presence or absence of a backward current, and generates the signal S_{ZX} that indicates the detection result. The signal S_{ZX} is a binary signal having low level or high level. The backward current detection circuit 39 sets the level of the signal S_{ZX} to low level in principle, and when detecting a backward current, it can change the level of the signal S_{ZX} to high level for a predetermined very short period of time (i.e., a one-shot pulse can be included in the signal S_{ZX}). The backward current is a current that flows from the node ND1 to the ground through the transistor M1, and corresponds to the negative inductor current I_{L}. During ON period of the transistor M1, the phenomenon that the polarity of the inductor current I_{L} reverses from positive to negative (i.e., the phenomenon that the potential at the node ND1 reverses from negative to positive) is also referred to as zero cross. Therefore, the signal S_{ZX} can be referred to as a zero cross detection signal or a backward current detection signal.

Typically, the backward current detection circuit 39 may monitor the polarity of the switch voltage V_{SW} during ON period of the transistor M1, so as to generate the signal S_{ZX}. However, it may also be possible that the backward current detection circuit 39 compares the switch voltage V_{SW} with a positive or negative predetermined very small voltage during ON period of the transistor M1, so as to generate the signal S_{ZX}. In other words, it may be possible that, during ON period of the transistor M1, the backward current detection circuit 39 determines whether or not the inductor current I_{L} satisfies a predetermined backward current condition, on the basis of a voltage between the ground and the node ND1 (i.e., the switching voltage V_{SW}), so as to generate the signal S_{ZX} on the basis of the determination result. The backward current detection circuit 39 sets the level of the signal S_{ZX} to low level in principle, and only if the backward current condition is satisfied, it is determined that the backward current is detected, and hence the level of the signal S_{ZX} is changed to high level for a predetermined very short period of time (i.e., a one-shot pulse is included in the signal S_{ZX}).

The backward current condition may be the following first, second or third condition. A backward current detection comparator (not shown) can be disposed in the backward current detection circuit 39. The backward current detection comparator compares the switch voltage V_{SW} (a determination voltage) with a predetermined backward current threshold voltage, and on the basis of the comparison result, it may be possible to determine whether or not the first, second or third condition is satisfied.

The first condition is satisfied when the polarity of the switch voltage V_{SW} reverses from negative to positive, during ON period of the transistor M1. In other words, the first condition is satisfied when the polarity of the inductor current I_{L} reverses from positive to negative, during ON period of the transistor M1. When the first condition is the backward current condition, it is sufficient that the backward current detection comparator compares the switch voltage V_{SW} with the backward current threshold voltage of 0 V. Note that the ON period of the transistor M1 is equal to the period during which the states of the transistors M1 to M4 are set to the state ST2.

The second condition is satisfied when the polarity of the switch voltage V_{SW} reverses from negative to positive and then the amplitude of the switch voltage V_{SW} reaches the backward current threshold value or higher, during ON period of the transistor M1. In other words, the second condition is satisfied when the polarity of the inductor current I_{L} reverses from positive to negative and then the amplitude of the inductor current I_{L} reaches a predetermined value or more, during ON period of the transistor M1. When the second condition is the backward current condition, it is sufficient that the positive backward current threshold value (e.g., +3 mV) is set to the value of the backward current threshold voltage, and that the backward current detection comparator compares the switch voltage V_{SW} with the backward current threshold voltage.

The third condition is satisfied when the polarity of the switch voltage V_{SW} is negative and the amplitude of the switch voltage V_{SW} is decreased to the backward current threshold value or less, during ON period of the transistor M1. In other words, the third condition is satisfied when the polarity of the inductor current I_{L} is positive and the amplitude of the inductor current I_{L} is decreased to a predetermined value or less, during ON period of the transistor M1. When the third condition is the backward current condition, it is sufficient that the negative backward current threshold value (e.g., -3 mV) is set to the value of the backward current threshold voltage, and that the backward current detection comparator compares the switch voltage V_{SW} with the backward current threshold voltage.

In the power supply device 1, the backward current threshold voltage may be changeable. For instance, the backward current threshold voltage may be changeably set in accordance with a value of a resistor that is externally connected to the external terminal of the electronic component including the control circuit 30. Alternatively, the backward current threshold voltage may be changeably set on the basis of a command issued from a not shown host system to the control circuit 30.

The clamp circuit 40 is connected to the wiring WR_{ERR}, and limits a decrease in the error voltage V_{ERR} so that the error voltage V_{ERR} does not decrease below a predetermined clamp voltage. Meaning of providing the clamp circuit 40 will be described later.

Hereinafter, in a plurality of examples, several specific configuration examples, operational examples, application techniques, variation techniques, and the like related to the power supply device 1 are described. The matters described above in this embodiment are applied to the following examples unless otherwise noted, and as long as no contradiction arises. In each example, if there is a matter that is incompatible with the matter described above, the description in each example can be prioritized. In addition, as long as no contradiction arises, among the plurality of examples described below, a matter described in any example can be applied to another example (i.e., among the plurality of examples, any two or more examples can be combined).

### <<First Example>>

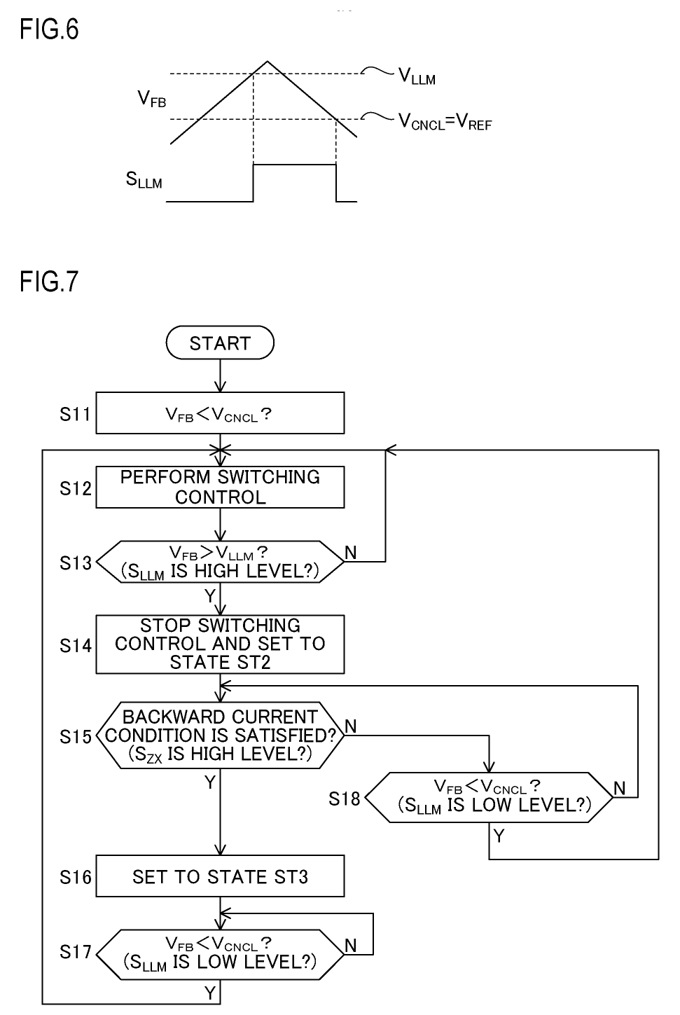

A first example is described below. FIG. 6 illustrates a relationship between the feedback voltage V_{FB} and the signal S_{LLM} output from the light load detection circuit 38. In the light load detection circuit 38, a cancellation voltage V_{CNCL} is defined in addition to the light load threshold voltage V_{LLM}. The cancellation voltage V_{CNCL} has a positive DC voltage value lower than the light load threshold voltage V_{LLM}. Here, it is supposed that the reference voltage V_{REF} described above is used as the cancellation voltage V_{CNCL} (i.e., it is supposed that "V_{CNCL} = V_{REF}" holds). However, the cancellation voltage V_{CNCL} may be a voltage a little higher or lower than the reference voltage V_{REF}.

The light load detection circuit 38 fixes the signal S_{LLM} to low level when "V_{FB} < V_{CNCL}" holds. When the feedback voltage V_{FB} increases from the state where the signal S_{LLM} is low level as a start point so that the feedback voltage V_{FB} exceeds the light load threshold voltage V_{LLM}, the light load detection circuit 38 changes the signal S_{LLM} from low level to high level. After the signal S_{LLM} becomes high level, as long as the feedback voltage V_{FB} does not become below the cancellation voltage V_{CNCL}, the light load detection circuit 38 keeps the signal S_{LLM} at high level. After the signal S_{LLM} becomes high level, when the feedback voltage V_{FB} becomes blow the cancellation voltage V_{CNCL}, the light load detection circuit 38 switches the signal S_{LLM} from high level to low level.

In order to realize the above operation, it may be possible to provide hysteresis characteristics having a hysteresis width of a difference voltage (V_{LLM}-V_{CNCL}) to the comparator 38a. In this case, it is possible to use an output signal itself of the comparator 38a as the signal S_{LLM}. Alternatively, it may be possible to dispose a first comparator (corresponding to the comparator 38a) that compares the feedback voltage V_{FB} with the light load threshold voltage V_{LLM}, and a second comparator that compares the feedback voltage V_{FB} with the cancellation voltage V_{CNCL} in the light load detection circuit 38, and to generate the signal S_{LLM} having the characteristics of FIG. 6 on the basis of comparison results of the comparators. Each of the first and the second comparators may be provided with hysteresis characteristics.

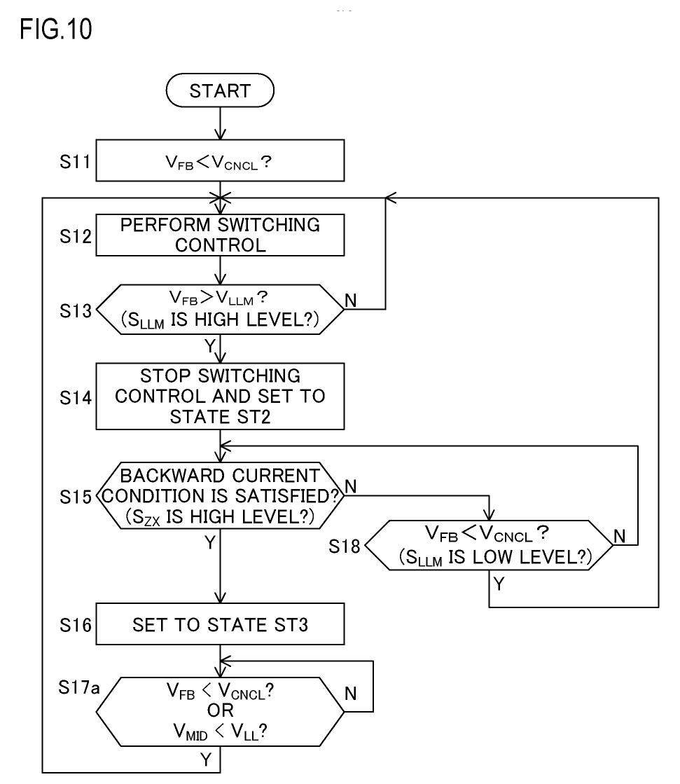

FIG. 7 illustrates a flowchart of operation of the power supply device 1. The flowchart of FIG. 7 can be said as a state transition diagram of the power supply device 1 (the same is true for the flowchart of FIG. 10 described later). In Step S11, it is supposed that the feedback voltage V_{FB} is sufficiently low, and at least "V_{FB} < V_{CNCL}" is satisfied so that the signal S_{LLM} is at low level. Then, transition from Step S11 to Step S12 is generated. In Step S12, the control circuit 30 performs the switching control described above. By the switching control, the states of the transistors M1 to M4 are switched alternately between the states ST1 and ST2.

In Step S13 after Step S12, the control circuit 30 determines whether or not "V_{FB} > V_{LLM}" is satisfied. Specifically, in Step S13, it is determined whether or not the signal S_{LLM} input to the controller 37 is high level. If "V_{FB} > V_{LLM}" is satisfied in Step S13 (i.e., if the signal S_{LLM} is high level), transition from Step S13 to Step S14 is generated. If "V_{FB} > V_{LLM}" is not satisfied in Step S13 (i.e., if the signal S_{LLM} is low level), the process returns from Step S13 to Step S12, and the switching control is continuously performed.

In the heavy load state, the transition to Step S14 is not generated, and the loop operation of Steps S12 and S13 is repeatedly performed. In contrast, in a light load state, the transition to Step S14 is generated. The light load state means a state where the load current I_{LD} is small to the extent that a rising edge is generated on the signal S_{LLM}.

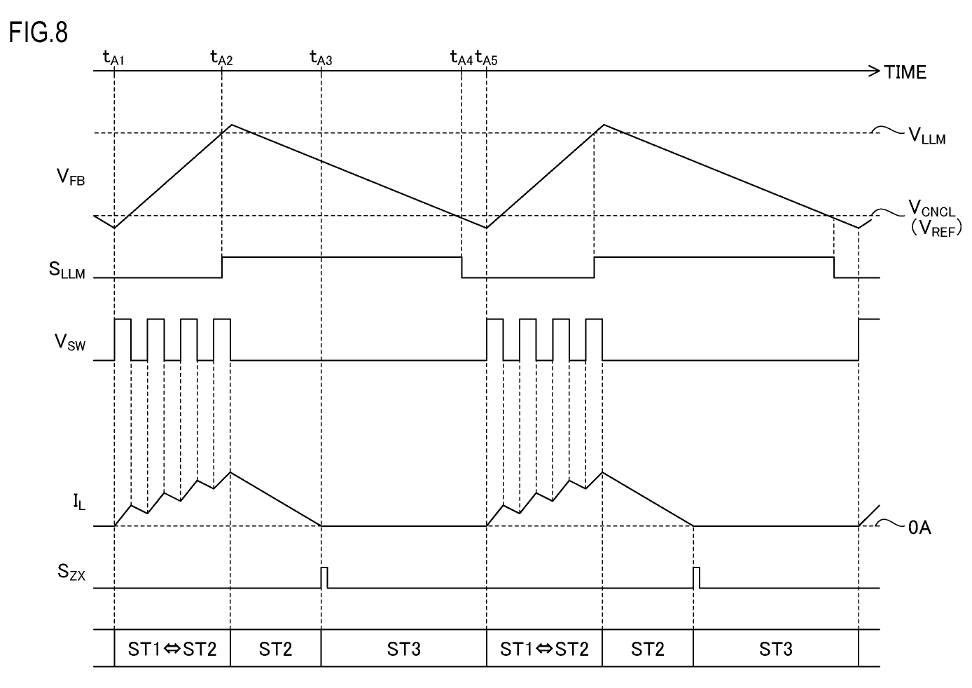

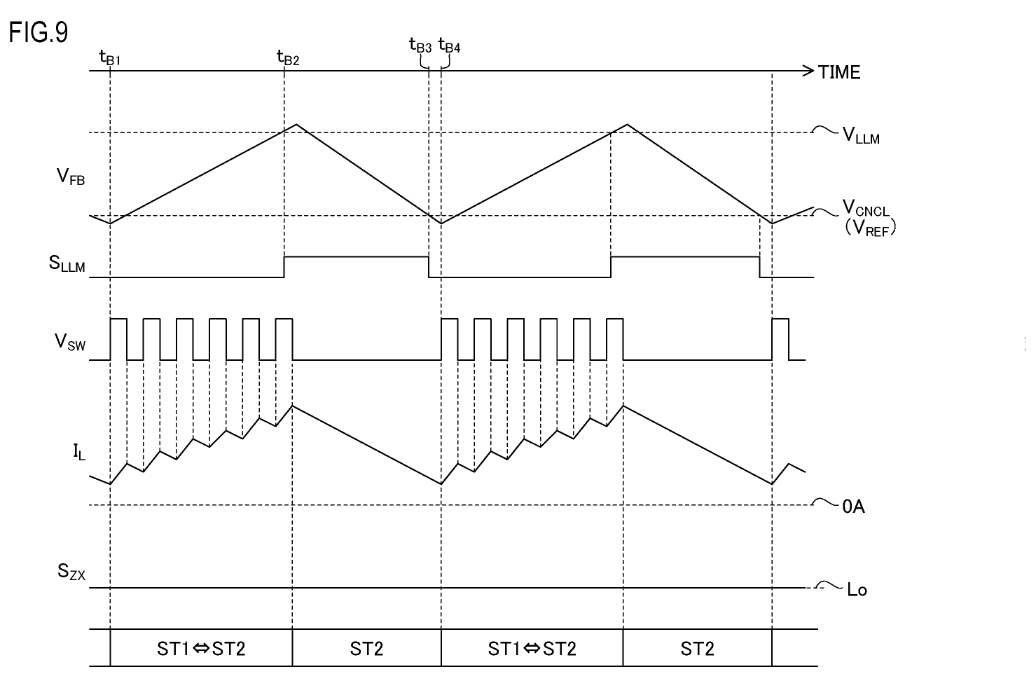

FIGS. 8 and 9 are timing charts of the power supply device 1 in the light load state. However, the load current I_{LD} when the timing chart of FIG. 8 is observed is smaller than the load current I_{LD} when the timing chart of FIG. 9 is observed. The load current I_{LD} in the heavy load state is larger than the load current I_{LD} in the light load state.

Therefore, the following consideration can be made. In the heavy load state, the load current I_{LD} has a current value I_{VAL1}. In other words, when the load current I_{LD} has the current value I_{VAL1}, the transition to Step S14 is not generated, and the switching control is continuously performed. The state where the load current I_{LD} has a current value I_{VAL2} or I_{VAL3} is the light load state. In the light load state, the transition to Step S14 is generated. Here, it is supposed that "I_{VAL1} > I_{VAL2} > I_{VAL3} > 0" is satisfied.

Among cases of operating in the light load state, in the case where the load current I_{LD} has the sufficiently small current value I_{VAL3}, the backward current condition is satisfied in Step S15 after the transition to Step S14 and before "V_{FB} < V_{CNCL}" is satisfied, and hence the loop operation through Steps S12 to S17 is repeatedly performed. The timing chart of FIG. 8 is a timing chart when the load current I_{LD} has the current value I_{VAL3}.

Among cases of operating in the light load state, in the case where the load current I_{LD} has the current value I_{VAL2}, the backward current condition is not satisfied while "V_{FB} < V_{CNCL}" is satisfied, and hence the loop operation consisting of Steps S12, S13, S14, S15, and S18 is repeatedly performed. The timing chart of FIG. 9 is a timing chart when the load current I_{LD} has the current value I_{VAL2}.

The process of Step S14 and after in FIG. 7 is described in detail. In Step S14, the control circuit 30 stops the switching control, and sets the states of the transistors M1 to M4 to the state ST2 (see FIG. 2). After Step S14, the process proceeds to Step S15. In Step S15, the control circuit 30 determines whether or not the backward current condition is satisfied. During the period where the states of the transistors M1 to M4 are set to the state ST2 in the stop period of the switching control, the control circuit 30 can determine whether or not the backward current condition is satisfied, on the basis of the switch voltage V_{SW} (i.e., on the basis of the voltage between the ground and the node ND1). Here, the backward current condition may be any one of the first to the third conditions described above. Only when the backward current condition is satisfied, the period where the signal S_{ZX} becomes high level is generated. In Step S15, if the backward current condition is satisfied, transition to Step S16 is generated. The controller 37 generates the transition to Step S16 when the signal S_{ZX} becomes high level. In Step S15, if the backward current condition is not satisfied, transition to Step S18 is generated. If the signal S_{ZX} is kept at low level, the controller 37 generates the transition to Step S18.

In Step S16, the control circuit 30 sets the states of the transistors M1 to M4 to the state ST3 (see FIG. 2). In Step S17 after Step S16, the control circuit 30 determines whether or not "V_{FB} < V_{CNCL}" is satisfied. After the transition to Step S16, unless "V_{FB} < V_{CNCL}" is satisfied, the control circuit 30 keeps the states of the transistors M1 to M4 in the state ST3. If "V_{FB} < V_{CNCL}" is satisfied, the control circuit 30 generates transition from Step S17 to Step S12, and resumes the switching control in Step S12. The controller 37 generates the transition from Step S17 to Step S12 when the signal S_{LLM} switches from high level to low level. After that, the operation of Step S12 and after is repeated.

In Step S18, the control circuit 30 determines whether or not "V_{FB} < V_{CNCL}" is satisfied. In Step S18, if "V_{FB} < V_{CNCL}" is not satisfied, the process returns to Step S15, and the determination process in Step S15 is performed again. In Step S18, if "V_{FB} < V_{CNCL}" is satisfied, the control circuit 30 generates transition from Step S18 to Step S12, and resumes the switching control in Step S12. The controller 37 generates the transition from Step S18 to Step S12 when the signal S_{LLM} switches from high level to low level. After that, the operation of Step S12 and after is repeated.

With reference to FIG. 8, an operation of the power supply device 1 in the case where the load current I_{LD} has the sufficiently small current value I_{VAL3} is described. In the case of FIG. 8, as time elapses, time points t_{A1}, t_{A2}, t_{A3}, t_{A4}, and t_{A5} come in this order.

In the case of FIG. 8, it is supposed that the switching control is stopped until just before time point t_{A1}. At time point t_{A1}, "V_{FB} < V_{CNCL}" is satisfied, and hence the signal S_{LLM} has low level. For this reason, the switching control is started at time point t_{A1} (Step S12). By the switching control started at time point t_{A1}, the inductor current I_{L} increases with fluctuation, and the output voltage V_{OUT} and the feedback voltage V_{FB} are gradually increased. At time point t_{A2}, the state where "V_{FB} < V_{LLM}" holds is changed to the state where "V_{FB} > V_{LLM}" holds, and hence a rising edge is generated on the signal S_{LLM} at time point t_{A2}.

By a trigger of the rising edge of the signal S_{LLM} at time point t_{A2}, transition from Step S13 to Step S14 is generated. Specifically, the controller 37 responds to the rising edge of the signal S_{LLM} at time point t_{A2} and stops the switching control, so as to set and fix the states of the transistors M1 to M4 to the state ST2 (Step S14).

However, if the states of the transistors M1 to M4 are in the state ST1 at time point t_{A2} (the time point when the rising edge is generated on the signal S_{LLM}), the controller 37 keeps the states of the transistors M1 to M4 in the state ST1 until the next rising edge of the signal CMPOUT is generated, and when the rising edge of the signal CMPOUT is generated, the controller 37 changes the states of the transistors M1 to M4 to the state ST2, and then fixes the states of the transistors M1 to M4 to the state ST2. Alternatively, it may be possible that, if the states of the transistors M1 to M4 are in the state ST1 at time point t_{A2}, the controller 37 promptly changes the states of the transistors M1 to M4 from the state ST1 to the state ST2 without waiting the next rising edge of the signal CMPOUT, and then fixes the same to the state ST2. If the states of the transistors M1 to M4 are in the state ST2 at time point t_{A2}, the controller 37 fixes the states of the transistors M1 to M4 to the state ST2 as they are.

In the case of FIG. 8, when the switching control is stopped by a trigger of the rising edge of the signal S_{LLM} at time point t_{A2}, the inductor current I_{L} decreases, and the backward current condition is satisfied at time point t_{A3}. In the case of FIG. 8, after time point t_{A2}, the output voltage V_{OUT} and the feedback voltage V_{FB} are gradually decreased, but "V_{FB} > V_{CNCL}" holds at time point t_{A3}. In other words, in the case of FIG. 8, after the switching control is stopped (Step S14), before "V_{FB} < V_{CNCL}" is satisfied, the backward current condition is satisfied at time point t_{A3} (Y in Step S15). In the control circuit 30, the signal S_{ZX} is set to high level for a very short period of time at time point t_{A3}, and the controller 37 receives the signal S_{ZX} of high level so as to change the states of the transistors M1 to M4 from the state ST2 to the state ST3 (Step S16). After that, the states of the transistors M1 to M4 are fixed to the state ST3 until the switching control is resumed at time point t_{A5}.

When the states of the transistors M1 to M4 are fixed to the state ST3, the backward current is suppressed, and a loss in the light load state is reduced. Also after time point t_{A3}, the decreases in the output voltage V_{OUT} and the feedback voltage V_{FB} continue. Further, at time point t_{A4}, the state where "V_{FB} > V_{CNCL}" holds is changed to the state where "V_{FB} < V_{CNCL}" holds, and hence a falling edge is generated on the signal S_{LLM} at time point t_{A4}.

When the controller 37 receives the falling edge of the signal S_{LLM} (i.e., receives the signal S_{LLM} of low level) at time point t_{A4}, it generates transition from Step S17 to Step S12, so as to resume the switching control. There can be a delay from the falling edge of the signal S_{LLM} to actual resuming of the switching control, depending on a circuit configuration or the like in the control circuit 30. In the example of FIG. 8, the switching control is resumed at time point t_{A5} a little after time point t_{A4}. In other words, in synchronization with the clock signal CLK, the states of the transistors M1 to M4 are changed from the state ST3 to the state ST1 at time point t_{A5}, and then the states of the transistors M1 to M4 are alternately changed between the states ST1 and ST2. However, time point t_{A4} and time point t_{A5} can be the same time point.

At time point t_{A5}, "V_{FB} < V_{CNCL}" is satisfied, and hence the signal S_{LLM} has low level. In other words, the state of the power supply device 1 at time point t_{A5} is the same as the state of the power supply device 1 at time point t_{A1}. Therefore, after the time point t_{A5}, the same operation as that from time point t_{A1} to just before time point t_{A5} is repeated.

With reference to FIG. 9, an operation of the power supply device 1 in the case where the load current I_{LD} has the current value I_{VAL2} larger than the current value I_{VAL3} is described below. In the case of FIG. 9, as time elapses, time points t_{B1}, t_{B2}, t_{B3}, and t_{B4} come in this order.

In the case of FIG. 9, it is supposed that the switching control is stopped until just before time point t_{B1}. At time point t_{B1}, "V_{FB} < V_{CNCL}" is satisfied, and hence the signal S_{LLM} has low level. For this reason, the switching control is started at time point t_{B1} (Step S12). By the switching control started at time point t_{B1}, the inductor current I_{L} increases with fluctuation, and the output voltage V_{OUT} and the feedback voltage V_{FB} are gradually increased. At time point t_{B2}, the state where "V_{FB} < V_{LLM}" holds is changed to the state where "V_{FB} > V_{LLM}" holds, and hence a rising edge is generated on the signal S_{LLM} at time point t_{B2}.

By a trigger of the rising edge of the signal S_{LLM} at time point t_{B2}, transition from Step S13 to Step S14 is generated. Specifically, the controller 37 responds to the rising edge of the signal S_{LLM} at time point t_{B2} so as to stop the switching control, and sets and fixes the states of the transistors M1 to M4 to the state ST2 (Step S14).

However, if the states of the transistors M1 to M4 are in the state ST1 at time point t_{B2} (the time point when the rising edge is generated on the signal S_{LLM}), the controller 37 keeps the states of the transistors M1 to M4 in the state ST1 until the next rising edge of the signal CMPOUT is generated, and when the rising edge of the signal CMPOUT is generated, the controller 37 changes the states of the transistors M1 to M4 to the state ST2, and then fixes the states of the transistors M1 to M4 to the state ST2. Alternatively, it may be possible that, if the states of the transistors M1 to M4 are in the state ST1 at time point t_{B2}, the controller 37 promptly changes the states of the transistors M1 to M4 from the state ST1 to the state ST2 without waiting the next rising edge of the signal CMPOUT, and then fixes the same to the state ST2. If the states of the transistors M1 to M4 are in the state ST2 at time point t_{B2}, the controller 37 fixes the states of the transistors M1 to M4 to the state ST2 as they are.

When the switching control is stopped by a trigger of the rising edge of the signal S_{LLM} at time point t_{B2}, the output voltage V_{OUT} and the feedback voltage V_{FB} and the inductor current I_{L} are decreased. However, in the case of FIG. 9, after time point t_{B2}, before the backward current condition is satisfied, "V_{FB} < V_{CNCL}" is satisfied. In other words, in the case of FIG. 9, after the switching control is stopped (Step S14), the backward current condition is not satisfied, and the state where "V_{FB} > V_{CNCL}" holds is changed to the state where "V_{FB} < V_{CNCL}" holds at time point t_{B3} (Y in Step S18 after N in Step S15). In the case of FIG. 9, because the backward current condition is not satisfied, the signal S_{ZX} is fixed to low level, while a falling edge is generated on the signal S_{LLM} at time point t_{B3}.

The controller 37 receives the falling edge of the signal S_{LLM} at time point t_{B3} (i.e., receives the signal S_{LLM} of low level), so as to resume the switching control by generating transition from Step S18 to Step S12. There can be a delay from the falling edge of the signal S_{LLM} to actual resuming of the switching control, depending on a circuit configuration or the like in the control circuit 30. In the example of FIG. 9, the switching control is resumed at time point t_{B4} a little after time point t_{B3}. In other words, in synchronization with the clock signal CLK, the states of the transistors M1 to M4 are changed from the state ST2 to the state ST1 at time point t_{B4}, and then the states of the transistors M1 to M4 are alternately changed between the states ST1 and ST2. However, time point t_{B3} and time point t_{B4} can be the same time point.

At time point t_{B4}, "V_{FB} < V_{CNCL}" is satisfied, and hence the signal S_{LLM} has low level. In other words, the state of the power supply device 1 at time point t_{B4} is the same as the state of the power supply device 1 at time point t_{B1}. Therefore, after time point t_{B4}, the same operation as that from time point t_{B1} to just before time point t_{B4} is repeated.

As described above, in the hybrid buck converter (the power supply device 1) in which the switched capacitor circuit and the synchronous buck converter are fused, the control of stopping the switching control and the control of turning off all the transistors M1 to M4 are performed in a light load. In this way, a loss in the light load state can be suppressed, and hence efficiency of the power supply device 1 can be improved.

### <<Second Example>>

A second example is described below. In the state ST3, the accumulated charge of the capacitor C_{MID} is basically retained, but in reality, the intermediate voltage V_{MID} is gradually decreased due to a leak current or the like of a transistor. When the switching control is resumed after stopping of the same, if the intermediate voltage V_{MID} is excessively decreased, the necessary inductor current I_{L} cannot be obtained just after the switching control is resumed, and hence stability of the output voltage V_{OUT} may be deteriorated.

In consideration of this, the control circuit 30 according to the second example sets the states of the transistors M1 to M4 to the state ST3 by the method described in the first example, and then monitors whether or not "V_{FB} < V_{CNCL}" and "V_{MID} < V_{LL}" are each satisfied, and resumes the switching control at time point when one of "V_{FB} < V_{CNCL}" and "V_{MID} < V_{LL}" is satisfied. V_{LL} indicates a lower limit voltage that is set corresponding to the intermediate voltage V_{MID}. The lower limit voltage V_{LL} has a predetermined positive DC voltage value. In order to determine whether or not "V_{MID} < V_{LL}" is satisfied, it is sufficient to dispose a lower limit determination comparator (not shown) that compares a high/low relationship between the intermediate voltage V_{MID} and the lower limit voltage V_{LL}, in the control circuit 30, and to input the comparison result by the lower limit determination comparator to the controller 37.

FIG. 10 illustrates a flowchart of an operation of the power supply device 1 according to the second example. In the flowchart of FIG. 7, Step S17 is replaced with Step S17a, and hence the flowchart of FIG. 10 is obtained. Except for this replacement, the flowcharts of FIGS. 7 and 10 are the same as each other, and the description in the first example can also be applied to the second example as long as no contradiction arises. In this application, the symbol "S17" in the first example is read as "S17a" in the second example.

After the states of the transistors M1 to M4 are set to the state ST3 in Step S16, the process proceeds to Step S17a in the second example. In Step S17a, the control circuit 30 determines whether or not "V_{FB} < V_{CNCL}" and "V_{MID} < V_{LL}" are each satisfied. In the second example, after transition to Step S16, unless at least one of "V_{FB} < V_{CNCL}" and "V_{MID} < V_{LL}" is satisfied, the control circuit 30 keeps the states of the transistors M1 to M4 in the state ST3. When at least one of "V_{FB} < V_{CNCL}" and "V_{MID} < V_{LL}" is satisfied, the control circuit 30 generates transition from Step S17a to Step S12, and resumes the switching control in Step S12. When the controller 37 receives the change of the signal S_{LLM} from high level to low level, or when it receives a signal indicating that "V_{MID} < V_{LL}" is satisfied from the lower limit determination comparator described above, it generates transition from Step S17a to Step S12.

### <<Third Example>>

A third example is described below. An effect of the clamp circuit 40 is described. A decrease in the load current I_{LD} causes a decrease in the error voltage V_{ERR}. On the other hand, the clamp circuit 40 limits a decrease in the error voltage V_{ERR} so that the error voltage V_{ERR} will not be below a predetermined clamp voltage. Therefore, if the load current I_{LD} is decreased in the state where a value of the error voltage V_{ERR} is equal to a value of the clamp voltage, an on-duty ratio of the buck converter consisting of the transistors M1 and M2 (a ratio of ON period of the transistor M2 to the sum of ON period and OFF period of the transistor M2) is increased, along with a decrease in the sense voltage V_{IL}. This increase in the on-duty ratio promotes an increase in the output voltage V_{OUT}, and hence "V_{FB} > V_{LLM}" is easily satisfied. In other words, the control of stopping the switching control and the control of turning off all the transistors M1 to M4 in the light load can be easily performed by disposing the clamp circuit 40. This contributes to suppression of loss in the light load state. However, it is not essential to dispose the clamp circuit 40 in the control circuit 30.

### <<Fourth Example>>

A fourth example is described below. The oscillation circuit 36 generates the clock signal CLK by an oscillation operation. The oscillation circuit 36 may generate the clock signal CLK by the oscillation operation during a low level period of the signal S_{LLM}, and may stop the oscillation operation during a high level period of the signal S_{LLM}. In this case, generation of the clock signal CLK is stopped during the high level period of the signal S_{LLM}. However, when the oscillation operation is resumed after stopping the same, some period of time may be necessary until the clock signal CLK is stably generated and output.

In consideration of this, the following control may be possible. The oscillation circuit 36 generates the clock signal CLK of a first frequency by a first oscillation operation during the low level period of the signal S_{LLM}, and generates the clock signal CLK of a second frequency by a second oscillation operation during the high level period of the signal S_{LLM}. The first frequency corresponds to the frequency f_{PWM} described above. The second frequency is lower than the first frequency. The clock signal CLK during the high level period of the signal S_{LLM} does not affect the operation of the controller 37, and during the high level period of the signal S_{LLM}, the states of the transistors M1 to M4 are set to the state ST2 or ST3 in accordance with the method described above.

In the high level period of the signal S_{LLM}, if the generation operation of the clock signal CLK is not completely stopped to generate the clock signal CLK of the second frequency, the switching control can be promptly resumed. In addition, because the second frequency is lower than the first frequency, power consumption of the oscillation circuit 36 during the high level period of the signal S_{LLM} can be suppressed to be lower than that during the low level period of the signal S_{LLM}.

### <<Fifth Example>>

A fifth example is described below. It may be possible to apply a modification, in which the adder 34 is eliminated from the control circuit 30 of FIG. 4, and instead, the current information of the inductor L1 is fed back to the error amplifier 31 side. In this modification, "V_{SLP} = V_{RAMP}" holds, and a voltage (V_{ERR} - V_{IL}) is input to the inverting input terminal of the PWM comparator 35. The PWM comparator 35 according to this modification sets the signal CMPOUT to low level if "V_{SLP} = V_{RAMP} < V_{ERR} - V_{IL}" holds, and sets the signal CMPOUT to high level if "V_{SLP} = V_{RAMP} > V_{ERR} - V_{IL}" holds.

### <<Sixth Example>>

A sixth example is described below. In the sixth example, variation technique, application technique, supplementary note, and the like for each matter described above are described.

The power supply device 1 according to the present disclosure can be applied to any device or system that requires a stable DC voltage. For instance, the power supply device 1 may be applied to a power supply system for a data center. In this case, for example, the output voltage V_{OUT} of the power supply device 1 may be 48 V, and the power supply device 1 supplies the output voltage V_{OUT} to a power supply bus of 48 V. In recent years, it is an important issue to reduce power consumption in the data center, and in this situation, replacements of power supply buses of 12 V with power supply buses of 48 V are proceeding. It is necessary to supply electric power from a power supply bus of 48 V to a server system, or to a storage device including a semiconductor memory, a magnetic disk, or the like, with high efficiency. Using the power supply device 1, it is possible to supply electric power with high efficiency.

Alternatively, the power supply device 1 may be applied to a primary power supply in a vehicle such as an automobile. In this case, the power supply device 1 may directly receive the input voltage V_{IN} from a battery mounted in the vehicle, so as to generate the output voltage V_{OUT}, and the output voltage V_{OUT} may function as a voltage for driving any system (e.g., an automated driving system of level 3 or higher) mounted in the vehicle. Alternatively, for example, the power supply device 1 may be applied to a power supply for a charging system. The charging system may be a system for charging a battery of an electric vehicle. Alternatively, for example, the power supply device 1 may be applied to a power supply for a base station.

For any signal or voltage, the relationship between high level and low level can be opposite to that described above, in a form where the spirit of the above description is not deteriorated.

The channel type of the FET (field-effect transistor) described in each embodiment is merely an example. The channel type of any FET can be changed between a P-channel type and an N-channel type, in a form where the spirit of the above description is not deteriorated. Therefore, for example, the transistors M1 to M4 may be constituted of P-channel type MOSFETs, or N-channel type MOSFETs and P-channel type MOSFETs may be mixed in the transistors M1 to M4.

As long as no inconvenience is caused, any transistor described above may be a transistor of any type. For instance, any transistor described above as a MOSFET can be replaced with a junction type FET, an IGBT (Insulated Gate Bipolar Transistor), or a bipolar transistor, as long as no inconvenience is caused. Any transistor has a first electrode, a second electrode, and a control electrode. In an FET, one of the first and the second electrodes is the drain, while the other is the source, and the control electrode is the gate. In an IGBT, one of the first and the second electrodes is the collector, while the other is the emitter, and the control electrode is the gate. In a bipolar transistor that is not classified as an IGBT, one of the first and the second electrodes is the collector, while the other is the emitter, and the control electrode is the base.

The embodiment of the present disclosure can be appropriately and variously modified within the scope of the technical concept recited in the claims. The embodiments described above are merely examples of the embodiments of the present disclosure, and meanings of terms in the present disclosure or of individual elements are not limited to those described in the above embodiments. Specific numeric vales shown in the above description are merely examples, and can be changed to various values as a matter of course.

### <<Additional Remarks>>

Additional remarks are given below for the present disclosure with the above embodiments in which specific configuration examples are shown.

A power supply device according to one aspect of the present disclosure includes a first switching element (M1) disposed between a reference node having a potential lower than an input voltage (V_{IN}) and a first node; a second switching element (M2) disposed between the first node and a second node; a third switching element (M3) disposed between the second node and a third node; and a fourth switching element (M4) disposed between the third node and a power supply node receiving the input voltage, in which the power supply device is configured to control states of the switching elements, so as to divide the input voltage and to step down an intermediate voltage (V_{MID}) obtained by the division, thereby generating an output voltage (V_{OUT}), the power supply device includes control circuit (30) configured to switch the states of the first to the fourth switching elements among a first state (ST1), a second state (ST2), and a third state (ST3), on the basis of information of the output voltage and current information of an inductor (L1) disposed between the first node and an output node applied with the output voltage, the second switching element and the fourth switching element are ON, while the first switching element and the third switching element are OFF, in the first state, the second switching element and the fourth switching element are OFF, while the first switching element and the third switching element are ON, in the second state, and the first to the fourth switching elements are all OFF in the third state (first configuration).

By adopting the method of dividing input voltage and then stepping down the voltage, a high-efficiency step-down operation can be realized. In this case, by allowing the control of turning off all the first to the fourth switching elements, loss in a light load can be reduced, and efficiency can be further improved.

In the power supply device according to the above first configuration, it may be possible to adopt a configuration (second configuration), in which the power supply device includes an intermediate capacitor (C_{MID}) disposed between the second node and the reference node, and a flying capacitor (C_{FLY}) disposed between the first node and the third node, and the control circuit performs switching control for switching the states of the first to the fourth switching elements between the first state and the second state, on the basis of the information of the output voltage and the current information of the inductor, so as to generate the intermediate voltage across both terminals of the intermediate capacitor and to generate the output voltage at the output node by stepping down the intermediate voltage.

In the power supply device according to the above second configuration, it may be possible to adopt a configuration (third configuration), in which after starting the switching control, if a feedback voltage corresponding to the output voltage exceeds a predetermined light load threshold voltage (V_{LLM}), the control circuit stops the switching control, and sets the states of the first to the fourth switching elements to the second state.

In the power supply device according to the above third configuration, it may be possible to adopt a configuration (fourth configuration), in which after starting the switching control, if a feedback voltage exceeds the light load threshold voltage, the control circuit stops the switching control and sets the states of the first to the fourth switching elements to the second state, and then on the basis of the feedback voltage and the inductor current, the control circuit sets the states of the first to the fourth switching elements to the third state or resumes the switching control.

In the power supply device according to the above fourth configuration, it may be possible to adopt a configuration (fifth configuration), in which after starting the switching control, if a feedback voltage exceeds the light load threshold voltage, the control circuit stops the switching control, and sets the states of the first to the fourth switching elements to the second state, and then if the feedback voltage does not fall below a cancellation voltage (V_{CNCL}) lower than the light load threshold voltage while the inductor current satisfies a predetermined backward current condition, the control circuit sets the states of the first to the fourth switching elements to the third state, and if the feedback voltage falls below the cancellation voltage before the inductor current satisfies the backward current condition, the control circuit resumes the switching control.

In the power supply device according to the above fifth configuration, it may be possible to adopt a configuration (sixth configuration), in which the control circuit sets the states of the first to the fourth switching elements to the third state, and then if the feedback voltage falls below the cancellation voltage, the control circuit resumes the switching control.

In the power supply device according to the above fifth configuration (see FIG. 10), it may be possible to adopt a configuration (seventh configuration), in which the control circuit sets the states of the first to the fourth switching elements to the third state, and then if the intermediate voltage falls below a predetermined lower limit voltage (V_{LL}), the control circuit resumes the switching control.

In the power supply device according to any one of the above fifth to seventh configurations, it may be possible to adopt a configuration (eighth configuration), in which during the period where the states of the first to the fourth switching elements are set to the second state in the stop period of the switching control, the control circuit determines whether or not the backward current condition is satisfied on the basis of a voltage between the first node and the reference node.

In the power supply device according to the above eighth configuration, it may be possible to adopt a configuration (ninth configuration), in which during the period where the states of the first to the fourth switching elements are set to the second state in the stop period of the switching control, the control circuit determines whether or not the backward current condition is satisfied, on the basis of a determination voltage (V_{SW}) corresponding to a potential at the first node with respect to a potential at the reference node, and the backward current condition is satisfied when polarity of the determination voltage reverses from negative to positive, or when the polarity of the determination voltage reverses from negative to positive and then amplitude of the determination voltage reaches a predetermined value or more, or when the polarity of the determination voltage is negative and the amplitude of the determination voltage decreases to a predetermined value or less.

In the power supply device according to any one of the above second to ninth configurations (see FIG. 5), it may be possible to adopt a configuration (tenth configuration), in which in the switching control, by a trigger of a predetermined level change in a predetermined clock signal (CLK), the control circuit turns on the second switching element and the fourth switching element while turns off the first switching element and the third switching element, and then when a period of time (t_{ON}) corresponding to the information of the output voltage and the current information of the inductor elapses, the control circuit turns off the second switching element and the fourth switching element while turns on the first switching element and the third switching element.

In the power supply device according to any one of the above first to tenth configurations, it may be possible to adopt a configuration (eleventh configuration), in which an output capacitor (C_{OUT}) is disposed between the output node and the reference node.

1. A power supply device comprising:
a first switching element disposed between a reference node having a potential lower than an input voltage and a first node;
a second switching element disposed between the first node and a second node;
a third switching element disposed between the second node and a third node; and
a fourth switching element disposed between the third node and a power supply node receiving the input voltage, wherein
the power supply device is configured to control states of the switching elements, so as to divide the input voltage and to step down an intermediate voltage obtained by the division, thereby generating an output voltage, and wherein
the power supply device includes a control circuit configured to switch the states of the first to the fourth switching elements among a first state, a second state, and a third state, on the basis of information of the output voltage and current information of an inductor disposed between the first node and an output node applied with the output voltage,
in the first state, the second switching element and the fourth switching element are ON, while the first switching element and the third switching element are OFF,
in the second state, the second switching element and the fourth switching element are OFF, while the first switching element and the third switching element are ON, and
in the third state, the first to the fourth switching elements are all OFF.

2. The power supply device according to claim 1, comprising:
an intermediate capacitor disposed between the second node and the reference node; and
a flying capacitor disposed between the first node and the third node, wherein
the control circuit performs switching control for switching the states of the first to the fourth switching elements between the first state and the second state, on the basis of the information of the output voltage and the current information of the inductor, so as to generate the intermediate voltage across both terminals of the intermediate capacitor and to generate the output voltage at the output node by stepping down the intermediate voltage.

3. The power supply device according to claim 2, wherein after starting the switching control, if a feedback voltage corresponding to the output voltage exceeds a predetermined light load threshold voltage, the control circuit stops the switching control, and sets the states of the first to the fourth switching elements to the second state.

4. The power supply device according to claim 3, wherein after starting the switching control, if the feedback voltage exceeds the light load threshold voltage, the control circuit stops the switching control and sets the states of the first to the fourth switching elements to the second state, and then on the basis of the feedback voltage and the inductor current, the control circuit sets the states of the first to the fourth switching elements to the third state or resumes the switching control.

5. The power supply device according to claim 4, wherein after starting the switching control, if the feedback voltage exceeds the light load threshold voltage, the control circuit stops the switching control, and sets the states of the first to the fourth switching elements to the second state, and then if the feedback voltage does not fall below a cancellation voltage lower than the light load threshold voltage while the inductor current satisfies a predetermined backward current condition, the control circuit sets the states of the first to the fourth switching elements to the third state, and if the feedback voltage falls below the cancellation voltage before the inductor current satisfies the backward current condition, the control circuit resumes the switching control.

6. The power supply device according to claim 5, wherein the control circuit sets the states of the first to the fourth switching elements to the third state, and then if the feedback voltage falls below the cancellation voltage, the control circuit resumes the switching control.

7. The power supply device according to claim 5, wherein the control circuit sets the states of the first to the fourth switching elements to the third state, and then if the intermediate voltage falls below a predetermined lower limit voltage, the control circuit resumes the switching control.

8. The power supply device according to claim 5, wherein during the period where the states of the first to the fourth switching elements are set to the second state in the stop period of the switching control, the control circuit determines whether or not the backward current condition is satisfied on the basis of a voltage between the first node and the reference node.

9. The power supply device according to claim 8, wherein
during the period where the states of the first to the fourth switching elements are set to the second state in the stop period of the switching control, the control circuit determines whether or not the backward current condition is satisfied, on the basis of a determination voltage corresponding to a potential at the first node with respect to a potential at the reference node, and
the backward current condition is satisfied when polarity of the determination voltage reverses from negative to positive, or when the polarity of the determination voltage reverses from negative to positive and then amplitude of the determination voltage reaches a predetermined value or more, or when the polarity of the determination voltage is negative and the amplitude of the determination voltage decreases to a predetermined value or less.

10. The power supply device according to claim 2, wherein in the switching control, by a trigger of a predetermined level change in a predetermined clock signal, the control circuit turns on the second switching element and the fourth switching element while turns off the first switching element and the third switching element, and then when a period of time corresponding to the information of the output voltage and the current information of the inductor elapses, the control circuit turns off the second switching element and the fourth switching element while turns on the first switching element and the third switching element.

11. The power supply device according to claim 1, wherein an output capacitor is disposed between the output node and the reference node.
